(19) United States
(12) Patent Application Publication
(10) Pub. No.: US 2025/0198230 A1
(43) Pub. Date: Jun. 19, 2025

(54) Reinforced Overhead Door

(71) Applicant: Arm-R-Lite Door Manufacturing Company, Inc., Piscataway, NJ (US)

(72) Inventors: Robert D. Marsh, Far Hills, NJ (US); Shannon L. Mcgrady, Far Hills, NJ (US)

(73) Assignee: Arm-R-Lite Door Manufacturing Company, Inc., Piscataway, NJ (US)

(21) Appl. No.: 18/545,710

(22) Filed: Dec. 19, 2023

(51) Int. Cl. E06B 3/54; E06B 3/70; E06B 7/23

(52) U.S. Cl. CPC E06B 3/549; E06B 3/70; E06B 7/23; E06B 2003/7044

(57) ABSTRACT

A reinforced overhead door includes an extruded rail extending along a width direction of the overhead door, the extruded rail being defined by an enclosed wall and a cavity therein. The enclosed wall includes a protruding portion defining part of an interior facing surface of the enclosed wall. The door further includes a pair of exterior members and a glazing panel couplable onto the extruded rail. The glazing panel is received on the extruded rail on an exterior side of the protruding portion separate from the protruding portion and the pair of exterior members are coupled exterior to the glazing panel to secure the glazing panel to the extruded rail. The glazing panel is positioned such that the protruding portion and the glazing panel are on the same side of the extruded rail facing away from the ground when the overhead door is mounted and closed.

### BACKGROUND OF THE INVENTION

Overhead roll-up doors are commonly employed in residential and commercial applications. In many circumstances, overhead doors are installed at a periphery of a building to provide controlled access to the building and to act as a barrier between the interior of the building and ambient elements outside the building. The exterior of such doors can be exposed to elements such as heat, water, wind and can be impacted by objects carried by high winds. The impact of such objects may cause damage to the overhead door that undesirably exposes the interior of the building to external elements. Furthermore, overhead doors often include glazing arranged along the door, e.g., in rows, columns or in a grid formation. Exposure to the elements and impaction from objects can cause deglazing, or disposition of glazing panels, compromising the building of its protection from the elements.

In view of the foregoing, it would be desirable to have overhead doors constructed with greater strength and durability so that such doors would exhibit greater stability and provide an enhanced barrier against exposure to ambient conditions outside of the door.

### BRIEF SUMMARY OF THE INVENTION

According to a first aspect of the disclosure, an overhead door may include a first row of panels, a second row of panels, and a seal. The first row of panels may include a lower extruded rail extending along a lengthwise direction of the first row of panels, the lower extruded rail may include a first exterior facing surface, a first interior facing surface, a first lower surface and a first upper surface, and the respective surfaces may define a first enclosure. The second row of panels may be adjacent to the first row of panels and may include an upper extruded rail extending along a lengthwise direction of the second row of panels, the upper extruded rail may include a second exterior facing surface, a second interior facing surface, a second lower surface and a second upper surface, and the respective surfaces may define a second enclosure. The seal may be disposed between the second upper surface and the first lower surface. A portion of the second exterior facing surface may cover a recessed portion of the first exterior facing surface. The second lower surface may include one of a protrusion and a recess and the first upper surface may include the other of the protrusion and the recess. The protrusion may be disposed in the recess and may be further from the first exterior facing surface than the seal.

Further in the overhead door of the first aspect of the disclosure, the first exterior facing surface may include a recessed portion configured to receive the extension. The portion of the second exterior facing surface may include an extension positioned on an exterior side of the door and may be configured to make contact with the lower extruded rail to form a seal. The seal may be disposed within a groove defined by the upper extruded rail and may be configured to form a seal between the lower and upper extruded rails. The seal may be formed of rubber. The lower extruded rail may include the protrusion and the upper extruded rail may define the recess, and the protrusion may extend into the recess.

According to a second aspect of the disclosure, an overhead door may include an extruded rail, a pair of exterior members, and a glazing panel. The extruded rail may extend along a width direction of the overhead door between sides of the overhead door, the extruded rail may be defined by an enclosed wall with a cavity therein, and the enclosed wall may include a protruding portion defining part of an interior facing surface of the enclosed wall. The pair of exterior members may be couplable onto the extruded rail proximate an exterior surface of the extruded rail. The glazing panel may be couplable onto the extruded rail. When the glazing panel is received on the extruded rail on an exterior side of the protruding portion separate from the protruding portion, the pair of exterior members may be coupled exterior to the glazing panel to secure the glazing panel to the extruded rail. The glazing panel may be positioned such that the protruding portion and the glazing panel are on the same side of the extruded rail facing away from the ground when the overhead door is mounted and in a closed position.

Further in the overhead door according to the second aspect of the disclosure, the overhead door may further include a spacer configured to be coupled to the protruding portion and separating the protruding portion from the glazing panel. A kit for assembling the overhead door of the second aspect of the disclosure may include the spacer configured to be coupled to the protruding portion, wherein the spacer may be a first spacer having a first size. The kit may further include at least a second spacer having a second size different from the first size and configured to be interchangeable with the first spacer within the overhead door. The kit may further include the glazing panel, wherein the glazing panel is a first glazing panel having a first thickness. The kit may further include at least as second glazing panel having a second thickness and configured to be interchangeable with the first glazing panel within the overhead door. One of the first spacer and the at least second spacer may be configured to be selected for installation in the overhead door. One of the first glazing panel and the at least second glazing panel may be configured to be selected for installation in the overhead door. The selection of the first and at least second spacer may be determined based on the selection of the first and at least second glazing panel.

Further in the overhead door according to the second aspect of the disclosure, the cavity may include a first cavity and a second cavity. The second cavity may be within a wall portion that defines the protruding portion. The overhead door may include a positioning fastener configured to be coupled to the protruding portion of the extruded rail. The glazing panel may be configured to abut sealant on interior and exterior sides of the glazing panel. The glazing panel may be a first glazing panel. The extruded rail may include a lower extruded rail positioned along a bottom of the first glazing panel and an upper extruded rail positioned along a top of a second glazing panel. The first glazing panel may be received on the lower extruded rail, and the protruding portion may be a first protruding portion extending from the lower extruded rail. The overhead door may further include the second glazing panel received on the upper extruded rail, and the upper extruded rail may include a second protruding portion which mirrors the first protruding portion such that the second glazing panel is positioned on an exterior side of the second protruding portion. The overhead door may further include a mullion extending in a direction perpendicular to the extruded rail. The mullion may couple the extruded rail to at least a second extruded rail. An intersection of the mullion and the extruded rail may form four receiving corners, and a first glazing panel may be configured to be received by two of the four receiving corners and a second glazing panel may be configured to be received by the other two of the four receiving corners. The mullion may be formed monolithically with the extruded rail.

Further in the overhead door according to the second aspect of the disclosure, the overhead door may further include a reinforcing member disposed within the cavity, and the reinforcing member may have a length along the width direction of the overhead door and a cross-sectional dimension extending from an exterior side of the enclosed wall to an interior side of the enclosed wall. The reinforcing member may include an elongate central body, an inner end portion extending transversely from the central body and an outer end portion extending transversely from the central body opposite the inner end portion. The inner end portion and the outer end portion may be oriented perpendicular to the central body. The inner end portion may be received within a recess defined by a pair of opposing protrusions extending from the enclosed wall into the cavity such that the inner end portion may be surrounded on at least a portion of each of four sides by the enclosed wall and the opposing pair of protrusions. The extruded rail may be a first extruded rail and the pair of exterior members may be a first pair of exterior members, and the overhead door may further include a second extruded rail spaced apart from the first extruded rail and a second pair of exterior members couplable onto the second extruded rail, wherein when the glazing panel is received on the first extruded rail, the second pair of exterior members may be coupled exterior to the glazing panel such that four exterior members secure the glazing panel from the exterior side.

According to a third aspect of the disclosure, an overhead door may include an extruded rail and a reinforcing member. The extruded rail may extend across a width of the overhead door. The extruded rail may define a thickness of the door, and the thickness may extend from an interior side of the door to an exterior side of the door. The reinforcing member may be disposed within a cavity of the extruded rail. The reinforcing member may extend across the thickness of the door from the interior side of the door to the exterior side of the door. The reinforcing member may include a central body, an inner end portion extending from the central body and an outer end portion extending from the central body opposite the inner end portion. The inner end portion may be fastened to the extruded rail with a fastener.

Further in the overhead door according to the third aspect of the disclosure, the inner end portion and the outer end portion may be elongate extending perpendicular to the central body. The inner end portion may extend farther in a downward direction than an upper direction relative to the central body and the outer end portion may extend farther in the upper direction than the downward direction relative to the central body. The overhead door may further include the fastener extending through an interior side of the extruded rail and the inner portion of the reinforcing member to couple the reinforcing member to the extruded rail. The extruded rail may include a pair of opposing protrusions defining a recess therebetween sized and shaped to receive the inner end portion. The inner end portion may be surrounded at least partially on all sides by the extruded rail. The cavity may be an enclosed cavity. The extruded rail may include an upper rail portion and a lower rail portion.

According to a fourth aspect of the disclosure, a method of manufacturing an overhead door may include forming a frame of the door with at least one extruded rail extending across a width of the overhead door, the extruded rail being formed monolithically and including a lip protruding from a remainder of the extruded rail in a direction perpendicular to the width of the overhead door; disposing a first sealing member onto the frame from an exterior side of the overhead door such that the first sealing member is limited from movement in an interior direction by the lip; positioning a glazing panel onto the frame from the exterior side of the overhead door such that an interior side of the glazing panel abuts the first sealing member; and disposing a second sealing member onto the frame from the exterior side of the overhead door to abut an exterior side of the glazing panel, thereby securing the glazing panel to the extruded rail.

Further in the method of manufacturing an overhead door according to the fourth aspect of the disclosure, disposing the first sealing member may include coupling the first sealing member to a threaded slot defined by a wall of the lip. The glazing panel may be positioned to abut a seal and sealant. The method may further include coupling a spacer to the lip of the extruded rail before the step of disposing the first sealing member. The disposing the first sealing member may include coupling the first sealing member to a threaded slot defined by the spacer and fastening a positioning fastener to the spacer and the wall of the lip. The glazing panel may be positioned to abut a seal and sealant. Forming the frame may include coupling a plurality of extruded rails with a plurality of mullions extending in a direction perpendicular to the extruded rails and intersecting the plurality of extruded rails to form a grid defining a plurality of sections, wherein positioning the glazing panel may include positioning a glazing panel within each section. Disposing the first sealing member onto the frame may include disposing a sealing member on each of four corners defined by one of the sections. Disposing the second sealing member onto the frame may include disposing a second sealing member on each of four corners defined by one of the sections. The glazing panel may be secured to the extruded rail by coupling an exterior snap-in member to the extruded rail to abut an exterior surface of the glazing panel. Coupling the exterior snap-in member to the extruded rail may include coupling a first end of the exterior snap-in member to an outer overhang formed by the extruded rail and coupling a second end of the exterior snap-in member to an inner overhang formed by the extruded rail. The lip may extend across at least a portion of the width of the overhead door and may protrude from the extruded rail.

### BRIEF DESCRIPTION OF THE DRAWINGS

FIG. 1 is a front, outside view of an overhead door according to an embodiment of the disclosure.

FIG. 2 is a rear, inside view of the overhead door of FIG. 1.

FIG. 3 is a side view of the overhead door of FIG. 1.

FIG. 4 is a top view of a partial cross-section through the overhead door of FIG. 1.

FIG. 5 is a side view of a partial cross-section through the overhead door of FIG. 1.

FIG. 6 is a top view of a partial cross-section through the overhead door of FIG. 1.

FIG. 7 is a cross-section of an extruded rail of FIG. 5, shown in isolation.

FIG. 8 is a cross-section of a mullion of FIG. 6, shown in isolation.

FIG. 9 is a side view of a reinforcing member of FIG. 5, shown in isolation.

FIG. 10 is a side view of an exterior snap-in member of FIG. 5, shown in isolation.

FIGS. 11A-11C are side views of spacer shown in isolation according to some embodiments of the disclosure, where one such spacer may be placed into a frame in accordance with the arrangement shown in FIG. 5, for example.

### DETAILED DESCRIPTION

As used herein, the terms “about,” “generally,” “approximately,” and “substantially” are intended to mean that slight deviations from absolute are included within the scope of the term so modified. However, unless otherwise indicated, the lack of any such terms should not be understood to mean that such slight deviations from absolute are not included within the scope of the term so modified. It should be appreciated that like reference numerals refer to like elements throughout the disclosure.

The present disclosure describes a moveable reinforced overhead door and a method of manufacturing the door. In examples throughout the disclosure, components of the door will be described using directional terms such as “upward,” “downward,” “interior,” “exterior,” “inner” and “outer.” It should be noted that such terms are merely used for ease of description, and the components described herein are not limited to the specific directions as described. It is also noted that the door described herein is in a closed configuration when generally oriented along a vertical plane (e.g., extending upward from the ground) and is in an open configuration when the door is generally oriented in a horizontal plane (e.g., positioned overhead or a distance from the ground). The directional terms as mentioned above are referenced throughout the present disclosure to describe relative positions and/or orientations of components of the door when the door is in the closed configuration. Further, the directional term “interior” refers to a side of the door facing inside a building while the directional term “exterior” refers to a side of the door facing outside the building, i.e., outdoor ambient conditions.

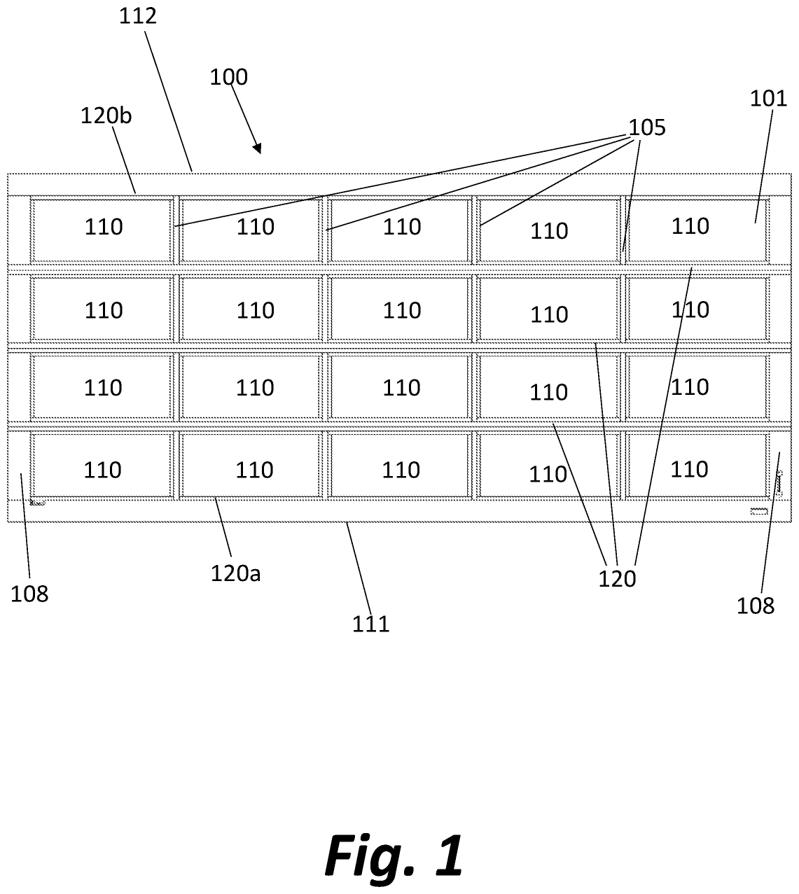

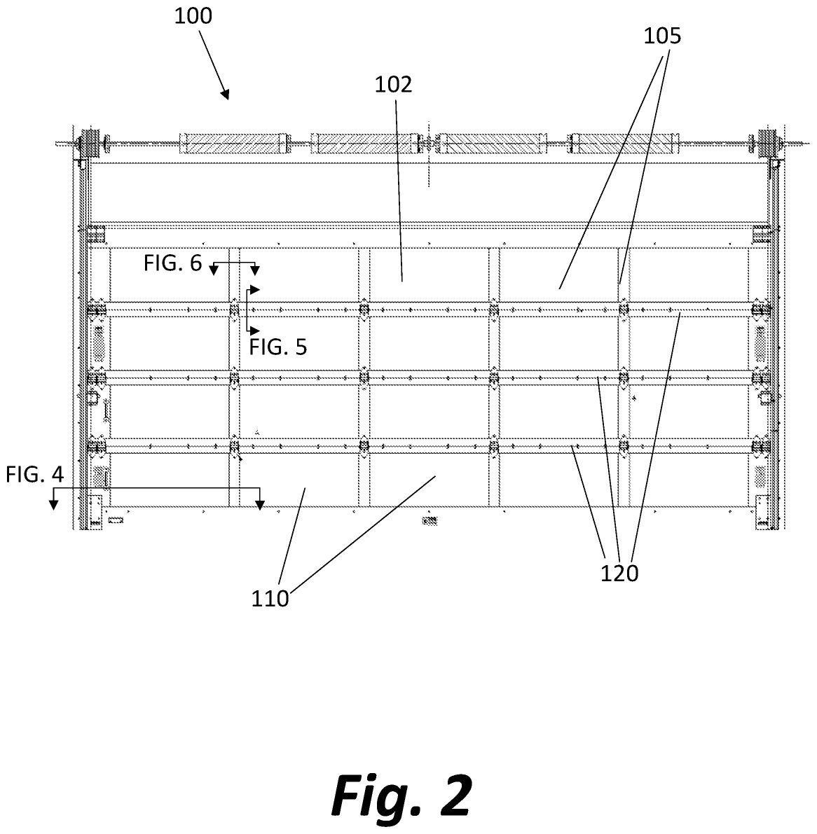

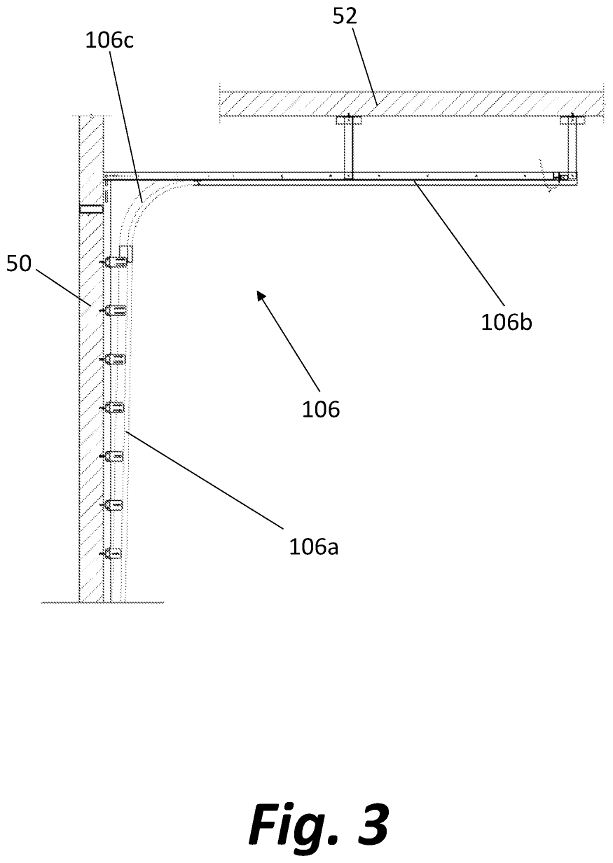

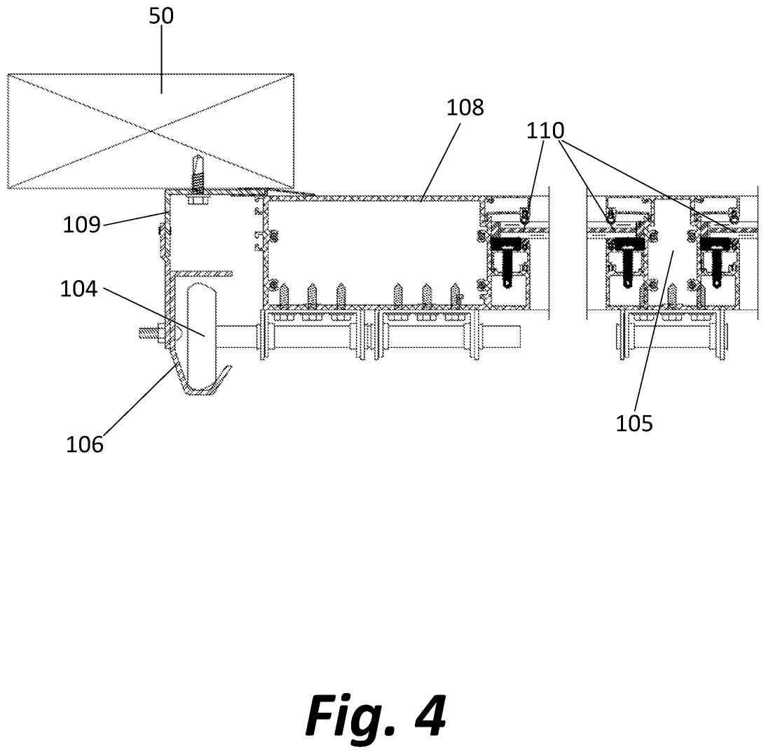

In a first aspect, the present disclosure relates to a roll-up overhead door that translates along a track to move between open and closed positions. Such door may be used in a wide variety of residential and commercial applications. One embodiment of an overhead door is shown in FIGS. 1-6 and is indicated by reference numeral 100. An exterior surface 101 of door 100 is illustrated in FIG. 1, e.g., a surface or side of the door that faces externally or away from the building in which the door is installed and is exposed to an outdoor environment. An interior surface 102 of door 100 is illustrated in FIG. 2, e.g., a surface or side of the door that faces internally or into the building in which the door is installed. A frame of door 100 includes a series of vertical and horizontal members. The vertical members include end stiles 108 at opposite sides of the door and a plurality of spaced-apart mullions 105 in between the end stiles, each of the end stiles and mullions extending in a vertical direction when the door is in the closed configuration. The horizontal members include a plurality of spaced-apart rails 120 extending in a horizontal direction between the end stiles. Mullions 105 may be spaced evenly apart from each other and rails 120 may be spaced evenly apart from each other. Such a spacing configuration is shown in FIG. 1, although it should be appreciated that the total number of members and the spacing of the vertical and horizontal members may vary to suit an intended purpose of the overhead door, such as varying section heights and widths allowing for different heights and widths of glazing panels within the same door. Thus, in another example, the mullions may be spaced apart irregularly, i.e., not evenly and/or the rails may be spaced apart irregularly, i.e., not evenly. Vertical mullions 105 cross rails 120 to form a grid defining a plurality of rectangles sized and configured to receive glazing panels 110. Glazing panels 110 can be, for example, windows or glass which may be transparent, translucent or opaque. For instance, glazing panels may include and/or be formed of tempered glass, polycarbonate, aluminum or insulating glass, and may be laminated. Some examples of glazing panels may include a sheet of a first material surrounded on each side by opposing sheets of a second material. While glazing panels having any thickness are contemplated, some examples include glazing panels having an overall thickness measuring 5/16 in, 7/16 in, ½ in, 9/16 in, and 1 in. It is also contemplated that a door may include any combination of different glazing panels with varying compositions and thicknesses. Details of how glazing panels 110 are received in the frame are described in greater detail elsewhere in the application. After assembly, door 100 is moveably coupled to track 106 as shown in FIG. 3. As depicted, track 106 includes a vertical portion 106a anchored to wall 50, a horizontal portion 106b anchored to ceiling 52, and a curved portion 106c connecting vertical portion 106a and horizontal portion 106b. Track 106 may be anchored to walls on respective sides of the door, such as wall 50, via a bracket 109 as shown in FIG. 4. Door 100 is coupled to wheels positioned laterally relative to the end stiles and positioned to be received in respective tracks on opposite sides of the door. One such wheel 104 is shown in FIG. 4, wheel 104 being adapted to travel along track 106 in a controlled manner to move door 100 between open and closed positions. Movement of door 100 along track 106 may be controlled through various technologies known to persons of ordinary skill in the art. For example, a motor may be connected to a belt to control rotation of a torsion spring above the door, the rotation of the torsion spring controlling movement of door 100 between the open and closed positions. The closed position may be characterized by when a substantial portion of door 100 is positioned in or adjacent vertical portion 106a of track 106, and the open position may be characterized by when a substantial portion of door 100 is positioned in or adjacent horizontal portion 106b of track 106. Components of door 100, including their manner of assembly, are described in greater detail below, including rails 120 and various components associated therewith.

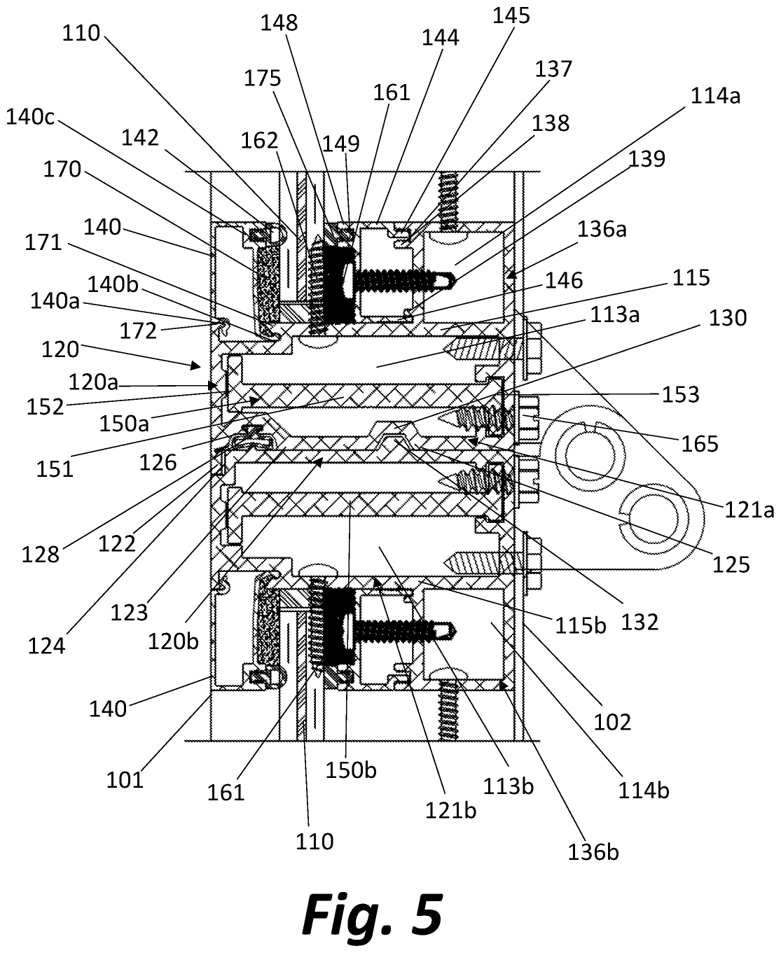

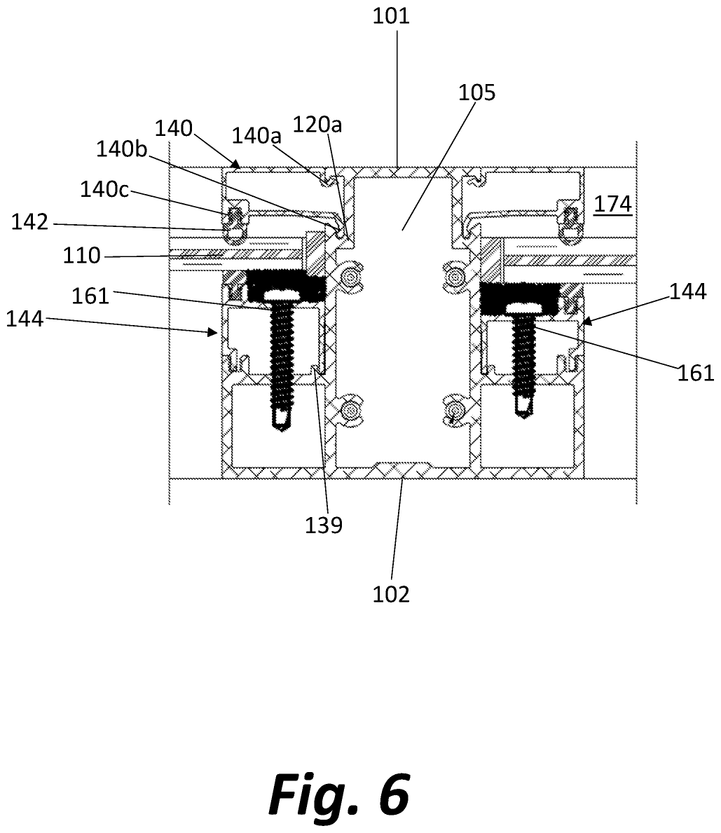

We now turn to the details of the various horizontal and vertical members that define the frame of door 100. Each rail 120 is located at a lowermost end, an uppermost end, or a horizontal joint of the door that allows for an angulation between opposite sides of the joint when the rail passes over curved portion 106c of track 106. A close-up cross-sectional view of such rail 120 is shown in FIG. 5. Rails 120 are intersected by spaced apart mullions 105, shown in FIG. 6, so that a space between a pair of adjacent mullions (or a mullion and end stile) and a pair of rails 120 may receive a glazing panel 110. Mullion 105 may include lips 136c laterally disposed relative to a central body of the mullion, the lips extending along the length of the mullion. Lips 136c may be monolithically formed with the central body of the mullion and are substantially similar to lip 136a in cross-sectional shape as shown in FIG. 6. In some examples, the rails may be extruded as individual components which may then be attached to separately extruded mullions and stiles. Each mullion may be cut and shaped to form a joint with the horizontal rails that are positioned orthogonally relative to the mullions. Attachment may be through welding of the mullions to the rails or the use of fasteners, among other means. In other examples, the rails and the mullions may be formed together monolithically for all or part of a single row of panels for a door, i.e., the rails and mullions formed between two adjacent door joints. For example, the rails and mullions defining five panels along the lowest row of door 100 as shown in FIG. 1 may be formed monolithically. In another example, part of such row may be formed monolithically.

As to the rails, such rails may include a single rail portion 120a at a lowermost end 111 of the door and a single rail portion 120b at an uppermost end 112 of the door (not shown in section), while at horizontal joints of door 100, rail 120 includes both upper rail portion 120a and lower rail portion 120b arranged to abut each other and form a seal therebetween when overhead door 100 is in a closed position. A sectional view of rail 120 at a joint along the door is shown in FIG. 5. A width of both upper and lower rail portions 120a, 120b defines a thickness of door 100 that extends from door exterior 101 to door interior 102.

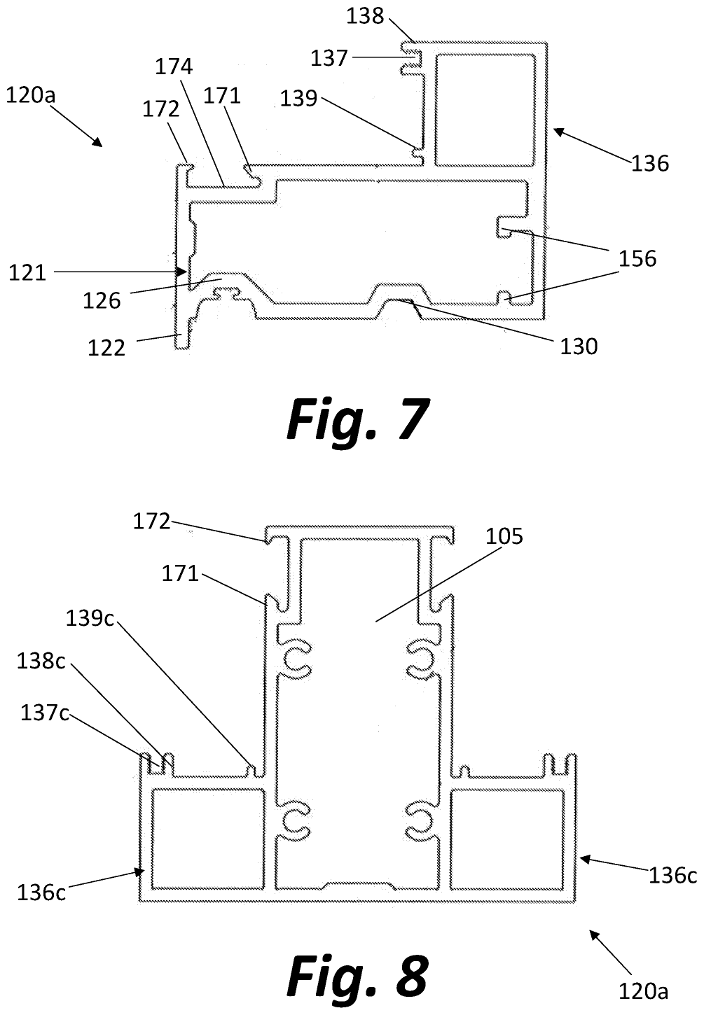

When viewed from a side view as shown in FIGS. 5 and 7, upper rail portion 120a includes a core body 121a, which generally forms an elongated rectangular cross-sectional shape, and a lip 136a extending from core body 121a in an upward direction on the interior side of upper rail portion 120a. As shown in FIG. 5, upper rail portion 120a includes an outer wall that defines first and second cavities 113a, 114a therein. An internal wall 115a separates first cavity 113a from second cavity 114a. Core body 121a of upper rail portion 120a interfaces with a core body 121b of lower rail portion 120b, and both upper rail portion 120a and lower rail portion 120b include a respective reinforcing member 150a, 150b disposed therein, where each reinforcing member extends from an exterior side to an interior side of the core body, as shown in FIG. 5. Disposable onto an upper surface of core body 121a is a spacer 144, which is secured in place by a positioning screw 161 advanced through spacer 144 and fastened to lip 136a. With the securement of sealant and a seal on an exterior side of spacer 144, a glazing panel 110 is positioned to abut the spacer on the side of the head of positioning screw 161, and an exterior snap-in member 140 is coupled to the core body 121a to abut an exterior surface of glazing panel 110, thereby holding a corner of glazing panel 110 in place. It should be appreciated that upper and lower rail portions 120a, 120b of rail 120 extend across an entire width of door 100 to maintain a seal, and lip 136a also continuously extends across the entire width of the door. The mullions may be milled so as to interlock with the rails. In some examples, the mullions are milled to interlock in part with a core body 121a and in part with a lip 136a, so that the lip may traverse a full width of the door uninterrupted.

A portion of the outer wall of upper rail portion 120a is positioned and shaped to complement a portion of an outer wall of the lower rail portion. Lower rail portion 120b generally has a similar outer wall, internal wall 113b, and cavities 113b, 114b to that of the upper rail portion. It is noted that with the exception of the components described below providing the three layers of protection from ambient elements which are positioned along an interface between upper rail portion 120a and lower rail portion 120b, the remaining parts of lower rail portion 120b included below the interface between rail portions may be generally a mirror image of the parts of upper rail portion 120a included above the interface between rail portions. And, it should be appreciated that while certain features of lower rail portion 120b are not explicitly described herein, like reference numerals for lower rail portion 120b refer to like elements in upper rail portion 120a. For example, lip 136b corresponds to and is substantially similar to lip 136a. Further, it should be appreciated that parts of the lower rail portion 120b behave in a manner substantially similar to their mirrored counterparts which are described hereinbelow.

As mentioned above, rail 120 includes a triple seal feature between upper rail portion 120a and lower rail portion 120b. Such seal is formed based on the following components of the rail. On a portion of outer wall on an exterior side of lower rail portion 120b, the wall includes recess 124. Complementing such recess 124, upper rail portion 120a includes extension 122 extending toward lower rail portion 120b along the exterior surface of the rail. Extension 122 is sized and shaped to be received by recess 124 such that the extension mates with the recess to form a first level of protection, e.g., a first seal, from the penetration of outdoor environmental elements such as wind and water.

Slightly offset in an interior direction from the exterior surface of rail 120, upper rail portion 120a defines an outer groove 126 such that the portion of upper rail portion 120a defining outer groove 126 is spaced farther from lower rail portion 120b than surrounding surface 123 of upper rail portion 120a surrounding outer groove 126. A section seal 128 is positioned within outer groove 126 to abut both upper rail portion 120a and lower rail portion 120b and be sandwiched therebetween. Section seal 128 may be generally plug-shaped and may be formed of rubber or other polymers which may be elastic to closely abut surrounding surfaces. Section seal 128 provides a second level of protection, e.g., a second seal, from penetration of environmental elements through the thickness of door 100. Upper rail portion 120a further defines inner groove 130 located further toward the interior of door 100 relative to outer groove 126. Inner groove 130 is shaped similarly to outer groove 126, wherein the portion of upper rail portion 120a defining inner grove 130 is spaced farther from lower rail portion 120b than surrounding surface 125 of upper rail portion 120a surrounding inner groove 130. Lower rail portion 120b includes a core body 121b with an upper surface facing upper rail portion 120a that is largely flat, though includes a protrusion 132 extending toward upper rail portion 120a. Protrusion 132 is spaced apart from the exterior and interior sides of the rail and is sized and shaped to be received by inner groove 130 such that the protrusion 132 mates with inner groove 130 to form a third level of protection, e.g., a third seal, from the penetration of outdoor environmental elements, such as water. Rail 120 therefore includes a first barrier formed by the mating of extension 122 and recess 124, a second barrier formed by outer groove 126 and section seal 128, and a third barrier formed by the mating of protrusion 132 with inner groove 130. As such, rail 120 is designed with three layers of protection from exposure to external elements, which significantly decreases the likelihood of any such elements passing from an exterior of the building in which door 100 is installed through the door and into an interior of the building.

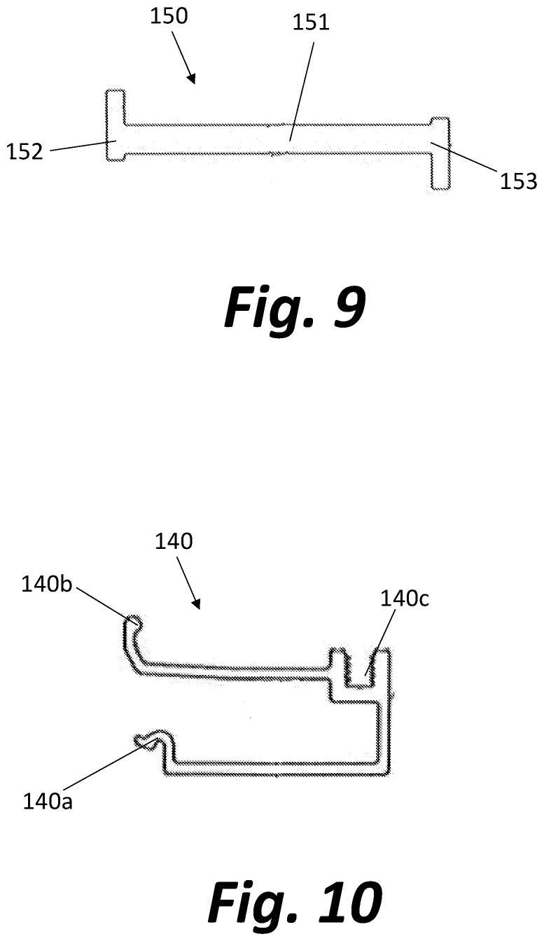

To strengthen rails 120, one or more rail portions 120a, 120b may include a reinforcing member 150a disposed therein, as shown in FIG. 5. For upper rail portion 120a, reinforcing member 150a is disposed within core body 121a and coupled to upper rail portion 120a to improve the load resistance and stability of door 100. Coupling may be through a fastener or through other means. As shown in FIGS. 5 and 9, reinforcing member 150a includes central body 151 in between outer end 152 and inner end 153. Outer end 152 is coupled to an exterior side of central body 151 and inner end 153 is coupled to an interior side of central body 151. In some variations, securement of the reinforcement may be through a combination of coupling and securing the reinforcing member through friction fit within the cavity of the rail. In cross-section, central body 151 is elongate, extending across nearly the entire thickness of door 100 between interior and exterior sides of upper rail portion 120a. As depicted, outer end 152 and inner end 153 are oriented in a direction perpendicular to the width direction of central body 151 as shown in FIG. 5. Outer end 152 extends in an upward direction relative to central body 151 and inner end 153 extends in the downward direction relative to central body 151. In variations, an extent of the upward and downward dimensions of the ends of the reinforcing member may vary from that shown. At the interior side of rail 120, core body 121a includes a pair of opposing protrusions 156 (see FIG. 7) defining a recess corresponding closely to the size of inner end 153 to receive inner end 153 therein, which contributes to securing reinforcing member 150a in place relative to rail 120. Inner end 153 may be surrounded at least partially on all four sides by surfaces of core body 121a to secure inner end 153 in place. At the exterior side of rail 120, core body 121a defines a height that complements a height of outer end 152 of reinforcing member 150a. As such, outer end 152 is surrounded and abutted on three sides by core body 121a to promote stability of reinforcing member 150a therein.

Coupling of the reinforcing member 150a to upper rail portion 120a may be via a fastener, among other means. In the depicted embodiment, inner end 153 of reinforcing member 150a is securely coupled to upper rail portion 120a by a fastener 165 inserted on an interior side of door 100 such that the shank of fastener 165 extends through both an interior side of upper rail portion 120a and inner end 153 of reinforcing member 150a. Reinforcing member may be formed of any extruded metal, preferably aluminum or aluminum alloy. Reinforcing member may have a length extending along an entire length of the rail portion within which it is disposed and in this respect may extend between opposing end stiles 108. Reinforcing member may be formed as a single monolithic member or may be formed of separate parts that are attached to each other. In the arrangement shown in FIG. 5, rail 120 includes two reinforcing members, reinforcing member 150a described above, and another reinforcing member disposed within and coupled to lower rail portion 120b. Reinforcing member 150b is a mirror image of reinforcing member 150a disposed within upper rail portion 120a and may include the same structure. It should also be appreciated that the cross-sectional portion of door 100 shown in FIG. 5 can be repeated and extrapolated for each adjacent pair of glazing panels 110 throughout the door.

Returning now to upper rail portion 120a and lip 136a in particular, lip 136 is defined by an outer wall portion that has a generally square or rectangular cross-section and is adapted to receive a shank of positioning fastener 161 to hold an optional spacer against the lip. Ultimately, irrespective of the arrangement, lip serves as a structure to hold a glazing panel in place and to provide a glazing panel installed in the panel with the lip with a greater resistance to failure when subject to pressure and forces, typically from outdoor environmental conditions, such as wind or impact. Advantageously, lip 136 may be formed monolithically with a remainder of central body 121a of upper rail portion 120a to provide enhanced performance for the combined glazing and frame structure when subject to outdoor conditions as described above.

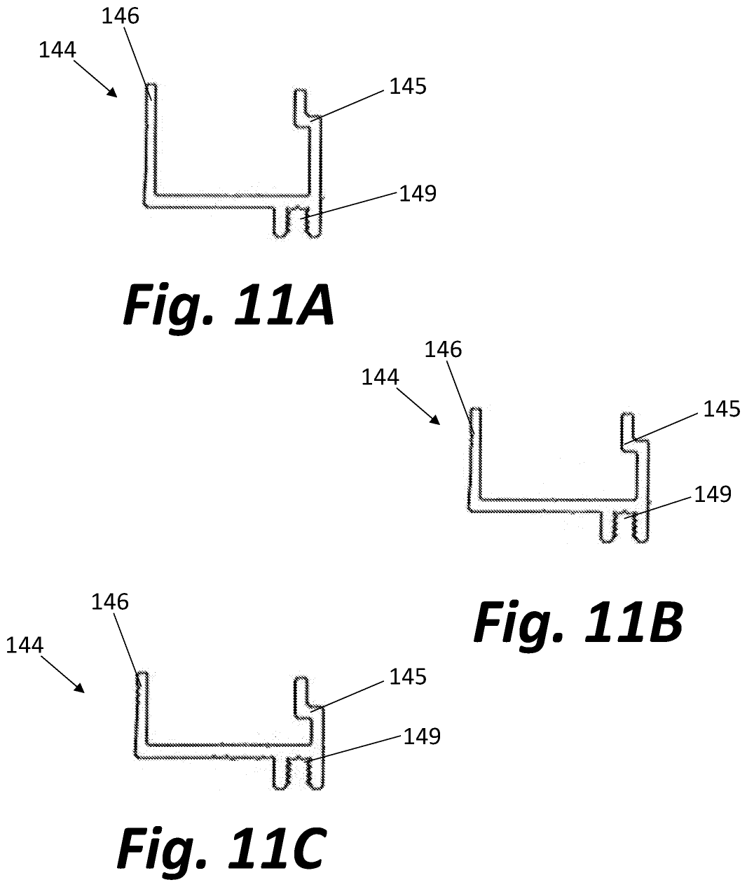

Lip 136 includes various features for engagement of other panel support components to the lip. An upper protuberance 138 extends from a superior portion of lip 136a toward door exterior 101, the upper protuberance 138 defines a threaded slot 137. Slot 137 is sized and shaped to receive an upper leg 145 of spacer 144, which is shown in FIGS. 5 and 11A-11C, or a seal 175 in some cases where a very thick glazing panel is installed. Located inferior to upper protuberance 138 is a lower protuberance 139 extending from lip 136a. Lower protuberance 139 forms a crevice with core body 121a, and the crevice is sized and shaped to snugly receive lower leg 146 of spacer 144. Thus, spacer 144 is coupled to lip 136a via the mating of upper leg 145 with slot 137 and lower leg 146 in the crevice formed by lower protuberance 139.

Positioning fastener 161 is inserted through spacer 144 such that the threaded shank of positioning fastener 161 extends through spacer 144 and lip 136a, terminating within the lip. Spacer 144 includes a protuberance 148 formed on an upper portion of spacer 144 and extending toward the exterior of door 100, the protuberance 148 being similar in size and shape to upper protuberance 138 of lip 136a. As such, protuberance 148 defines a threaded slot 149 which receives a seal 175 having a threaded shank therein. The head of positioning fastener 161 is disposed between protuberance 148 and core body 121a.

The exterior-facing surface of the head of positioning fastener 161 is substantially flat, allowing glazing panel 110 to be securely abutted proximate the head of positioning fastener 161 or to allow a sealant or other similar substance to be disposed between spacer 144 and glazing panel 110, as shown in FIG. 5. Glazing panel 110 is further secured in place by an exterior snap-in member 140 coupled to ledge surface 174 (FIGS. 6 and 7) on upper rail portion 120a on an opposite side of glazing panel 110 relative to lip 136a. Upper rail portion 120a defines a recess forming inner overhang 171 and outer overhang 172, which oppose one another across the recess. Exterior snap-in member 140 is generally U-shaped in cross-section extending from first end 140a to second end 140b and may have an overall shape such that it defines an interior volume with two open sides, one facing central bore 121a and the other a mullion or end stile. First end 140a is curved in a semi-circular shape to as to define a groove which is sized and shape to receive outer overhang 172. Second end 140b is curved to form a hook shape which is sized and shape to engage inner overhang 171, more specifically the recess formed by inner overhang 171. Exterior snap-in member 140 may have elasticity sufficient such that it may be elastically deformed with an application of pressure that may be achieved by the strength of a human hand, but in any event is sufficiently rigid to maintain its shape when coupled to outer overhang 172 and inner overhang 171 via first end 140a and second end 140b, respectively.

Exterior snap-in member 140 further defines an interior-facing slot 140c near its upper side. A glazing seal 142, which includes a threaded shank adapted to engage threaded slot 140c, is positioned within slot 140c such that glazing seal 142 extends from slot 140c and abuts glazing panel 110 to prevent the penetration of ambient elements beyond glazing panel 110. A sealant 170 is also placed along an exterior surface of glazing panel between exterior snap-in member 140 and glazing panel 110, which further protects glazing panel 110 from the penetration of elements. Further, glazing seal 142 is positioned adjacent sealant 170 to separate sealant 170 from exposure to environmental conditions exterior to the door. It should be appreciated that by providing interior support for glazing panel 110 with lip 136a, spacer 144 and positioning fastener 161, glazing panel becomes capable of withstanding greater forces acting on the door from the exterior while still remaining in place within door 100. Support is significantly improved relative to conventional designs by forming lip 136a monolithically with core body 121a of rail 120, thereby providing direct durable support on the interior side of the glazing panels and increasing the maximum load-bearing capacity of the glazing panels. Glazing panel 110 is significantly less likely to be deglazed or displaced from door 100 upon impaction from objects stirred around by heavy winds relative to a design without a lip structure arranged in the manner contemplated. It should be appreciated that while the depicted embodiment is described herein, variations of the depicted embodiment are also contemplated, such as variations that include rail components with different shapes or sizes or variations that may omit certain removable components.

In alternative examples, spacer 144 may be modified and components surrounding the spacer may differ to accommodate the modification. For instance, a size of spacer 144 may be increased or decreased such that the distance between lip 136a and glazing panel 110 is correspondingly increased or decreased. Examples of different sizes of spacers are shown in FIGS. 11A-11C. In these examples, the lengths of upper leg 145 and lower leg 146 remain approximately equal to each other, but differ in each example. That is, FIG. 11A illustrates a spacer having relatively long upper and lower legs, which may be used with a glazing panel 110 having a relatively small thickness to accommodate for the additional space present. Alternatively, FIG. 11C illustrates a spacer having relatively short upper and lower legs, which may be used with a glazing panel 110 having a relatively large thickness to accommodate for the smaller amount of space present. In further examples, glazing panel 110 may have a thickness large enough that the spacer is omitted from the door altogether. In such an example, positioning fastener 161 may be fastened directly into lip 136a so that the head of positioning fastener 161 is disposed closer to lip 136a, and seal 175 may be inserted (e.g., by threading) into threaded slot 137. In some variations of such example, fastener 161 may be omitted entirely. A glazing panel 110 thickness sufficient to warrant the omission of a spacer may be a thickness of approximately one inch or greater. It is contemplated that the components of door 100 described above may be welded, bolted, screwed together, or any combination thereof.

In a second aspect, the present disclosure relates to a method of manufacturing the door. The rails, mullions and end stiles may be formed by extruding strips of material, such as aluminum, steel, titanium or a metal alloy, to form the desired shape. Each rail, mullion and end stile may be extruded individually. The extruded strips may be coupled to one another to form a frame of the door, e.g., by welding, fasteners, bolts, etc. Where fasteners are used, the elements may be formed with fastener pockets. In some examples, individual rows of panels for the frame may be extruded and manufactured as a single piece such that the rails and mullions are monolithic. In other examples, other subparts within the individual rows of panels may be formed monolithically. After the frame is generally constructed, assembly of glazing panels and associated components for securing the glazing panel within the door may be carried out in a manner as described below.

In a third aspect, the present disclosure relates to a method of assembling door 100. In one embodiment, a frame of door 100 is first assembled from a plurality of extruded vertical mullions 105 and rails 120. One or more rails 120 may be modified to include a reinforcing member. For example, to reinforce upper rail portion 120a, reinforcing member 150a is disposed within and coupled to upper rail portion 120a by positioning outer end 152 within recess defined by protrusions 156 so that reinforcing member 150a abuts the interior side of upper rail portion 120a. Inner end 153 is positioned to abut the exterior side of upper rail portion 120a and complete the placement of reinforcing member 150a therewithin. After positioning reinforcing member 150a within upper rail portion 120a, fastener 165 is inserted through an exterior side of upper rail portion 120a and inner end 153 to fixedly couple reinforcing member 150a to rail 120. Additional fastening of reinforcing member may also be completed, as applicable. For example, to secure outer end 152 of reinforcing member.

Spacer 144 is coupled to lip 136a by positioning upper leg 145 within slot 137 defined by upper protuberance 138 and further positioning lower leg 146 within the crevice defined between lower protuberance 139 and core body 121a. Positioning fastener 161 is inserted through spacer 144 and lip 136a to fixedly coupled spacer 144 to rail 120. Seal 175 is positioned within slot 149 defined by spacer 144, such that the exterior-facing surfaces of seal 175 along with sealant disposed below seal 175 are adapted to receive glazing panel 110. Glazing panel 110 is inserted from the exterior side of door 110 and positioned against seal 175, and sealant 170 is applied to an exterior side of glazing panel 110. By inserting glazing panel 110 into position via the exterior side of the door against seal 175 and spacer 144, is the latter being securely fastened to lip 136a, glazing panel 110 is provided with durable support from the interior side to prevent displacement or deglazing due to impact from objects hitting the glazing from the exterior side of the door or wind or other external environmental conditions. Glazing panel 110 has enhanced tolerance for high impact forces and surface pressure due to its external placement within the thickness of the frame and through the monolithic formation of protruding lip 136a with a remainder of upper rail portion 120a and a location of lip 136a being on an interior side of the rail. Exterior snap-in member 140 is coupled to upper rail portion 120a by elastically deforming first end 140a and second end 140b to be coupled to outer overhang 172 and inner overhang 171, respectively. That is, first end 140a is positioned so that outer overhang 172 is received by the groove defined by first end 140a, and the hook-shaped second end 140b is inserted into the recess defined between inner overhang 171 and core body 121a. Exterior snap-in member 140 includes glazing seal 142 disposed within slot 140c, and glazing seal 142 abuts an exterior surface of glazing panel 110 upon installation of exterior snap-in member 140. Sealant 170 may also be disposed between glazing panel 110 and exterior snap-in member 140 during this process. For each glazing panel 110, the above steps are repeated three more times so that every corner of the glazing panel is secured within the frame. The method may continue for the installation of additional glazing panels of the door, as desired. It should be appreciated that any number of panels within a frame may be structured for the receipt of glazing panels as contemplated by the present disclosure.

In some examples, one or more glazing panels for the door is of a thickness relative to the rail 120 such that no spacer is required, in which case the step of positioning the spacer is omitted. In such instances, positioning fastener 161 is fastened directly to lip 136a or may be omitted entirely. Seal 175 is then inserted into slot 137, the seal, sealant internal to seal 175, and positioning fastener 161 still providing surfaces upon which to abut glazing panel 110 as in the example described above. The exclusion of a spacer creates additional space which allows for a thicker glazing panel 110 to be used.

The above process may be performed in reverse to remove one or more glazing panels. Thus, such process may begin with removing the exterior snap-in members.

It should be noted that substantially the same steps as described above to form a portion of door 100 can be repeated and extrapolated to all other portions of door 100 to install each glazing panel 110 and properly seal the same to prevent puncture, damage or other forms of failure due to pressures and forces that may occur in an environment exterior to the door.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An overhead door comprising:
a first row of panels including a lower extruded rail extending along a lengthwise direction of the first row of panels, the lower extruded rail including a first exterior facing surface, a first interior facing surface, a first lower surface and a first upper surface, the respective surfaces defining a first enclosure;
a second row of panels adjacent to the first row of panels, the second row of panels including an upper extruded rail extending along a lengthwise direction of the second row of panels, the upper extruded rail including a second exterior facing surface, a second interior facing surface, a second lower surface and a second upper surface, the respective surfaces defining a second enclosure; and
a seal disposed between the second upper surface and the first lower surface,
wherein a portion of the second exterior facing surface covers a recessed portion of the first exterior facing surface, and
wherein the second lower surface includes one of a protrusion and a recess and the first upper surface includes the other of the protrusion and the recess, the protrusion being disposed in the recess and being further from the first exterior facing surface than the seal.

2. The overhead door of claim 1, wherein the portion of the second exterior facing surface includes an extension positioned on an exterior side of the door and is configured to make contact with the lower extruded rail to form a seal.

3. The overhead door of claim 1, wherein the seal is disposed within a groove defined by the upper extruded rail and is configured to form a seal between the lower and upper extruded rails.

4. An overhead door comprising:
an extruded rail extending along a width direction of the overhead door between sides of the overhead door, the extruded rail being defined by an enclosed wall with a cavity therein, the enclosed wall including a protruding portion defining part of an interior facing surface of the enclosed wall;
a pair of exterior members couplable onto the extruded rail proximate an exterior surface of the extruded rail; and
a glazing panel couplable onto the extruded rail,
wherein when the glazing panel is received on the extruded rail on an exterior side of the protruding portion separate from the protruding portion, the pair of exterior members are coupled exterior to the glazing panel to secure the glazing panel to the extruded rail, the glazing panel being positioned such that the protruding portion and the glazing panel are on the same side of the extruded rail facing away from the ground when the overhead door is mounted and in a closed position.

5. The overhead door of claim 4, further comprising a spacer configured to be coupled to the protruding portion and separating the protruding portion from the glazing panel.

6. A kit for assembling the overhead door of claim 5, the kit comprising:
the spacer configured to be coupled to the protruding portion, wherein the spacer is a first spacer having a first size,
at least a second spacer having a second size different from the first size and configured to be interchangeable with the first spacer within the overhead door.

7. The kit of claim 6, further comprising:
the glazing panel, wherein the glazing panel is a first glazing panel having a first thickness, and
at least as second glazing panel having a second thickness and configured to be interchangeable with the first glazing panel within the overhead door.

8. The overhead door of claim 4, wherein the glazing panel is a first glazing panel, wherein the extruded rail includes a lower extruded rail positioned along a bottom of the first glazing panel and an upper extruded rail positioned along a top of a second glazing panel,
wherein the first glazing panel is received on the lower extruded rail, wherein the protruding portion is a first protruding portion extending from the lower extruded rail, and
wherein the overhead door further comprises the second glazing panel received on the upper extruded rail, the upper extruded rail including a second protruding portion which mirrors the first protruding portion such that the second glazing panel is positioned on an exterior side of the second protruding portion.

9. The overhead door of claim 4, further comprising a mullion extending in a direction perpendicular to the extruded rail, the mullion coupling the extruded rail to at least a second extruded rail, and
wherein an intersection of the mullion and the extruded rail forms four receiving corners, and wherein a first glazing panel is configured to be received by two of the four receiving corners and a second glazing panel is configured to be received by the other two of the four receiving corners.

10. The overhead door of claim 4, further comprising a reinforcing member disposed within the cavity, the reinforcing member having a length along the width direction of the overhead door and a cross-sectional dimension extending from an exterior side of the enclosed wall to an interior side of the enclosed wall.

11. The overhead door of claim 10, wherein the reinforcing member includes an elongate central body, an inner end portion extending transversely from the central body and an outer end portion extending transversely from the central body opposite the inner end portion.

12. The overhead door of claim 11, wherein the inner end portion is received within a recess defined by a pair of opposing protrusion extending from the enclosed wall into the cavity such that the inner end portion is surrounded on at least a portion of each of four sides by the enclosed wall and the opposing pair of protrusions.

13. The overhead door of claim 4, wherein the extruded rail is a first extruded rail and the pair of exterior members is a first pair of exterior members, further comprising a second extruded rail spaced apart from the first extruded rail and a second pair of exterior members couplable onto the second extruded rail, wherein when the glazing panel is received on the first extruded rail, the second pair of exterior members are coupled exterior to the glazing panel such that four exterior members secure the glazing panel from the exterior side.

14. A method of manufacturing an overhead door comprising:
forming a frame of the door with at least one extruded rail extending across a width of the overhead door, the extruded rail being formed monolithically and including a lip protruding from a remainder of the extruded rail in a direction perpendicular to the width of the overhead door;
disposing a first sealing member onto the frame from an exterior side of the overhead door such that the first sealing member is limited from movement in an interior direction by the lip;
positioning a glazing panel onto the frame from the exterior side of the overhead door such that an interior side of the glazing panel abuts the first sealing member; and
disposing a second sealing member onto the frame from the exterior side of the overhead door to abut an exterior side of the glazing panel, thereby securing the glazing panel to the extruded rail.

15. The overhead door of claim 14, wherein disposing the first sealing member includes coupling the first sealing member to a threaded slot defined by a wall of the lip.

16. The method of manufacturing the overhead door of claim 14, further comprising coupling a spacer to the lip of the extruded rail before the step of disposing the first sealing member.

17. The method of manufacturing the overhead door of claim 16, wherein the disposing the first sealing member includes coupling the first sealing member to a threaded slot defined by the spacer and fastening a positioning fastener to the spacer and the wall of the lip.

18. The method of manufacturing the overhead door of claim 14, wherein forming the frame includes coupling a plurality of extruded rails with a plurality of mullions extending in a direction perpendicular to the extruded rails and intersecting the plurality of extruded rails to form a grid defining a plurality of sections, wherein positioning the glazing panel includes positioning a glazing panel within each section.

19. The method of manufacturing the overhead door of claim 18, wherein disposing the first sealing member onto the frame includes disposing a sealing member on each of four corners defined by one of the sections.

20. The method of manufacturing the overhead door of claim 18, wherein disposing the second sealing member onto the frame includes disposing a second sealing member on each of four corners defined by one of the sections.
